(19) United States
(12) Patent Application Publication
(10) Pub. No.: US 2014/0123110 A1
(43) Pub. Date: May 1, 2014

(54) MONITORING AND IMPROVING SOFTWARE DEVELOPMENT QUALITY

(71) Applicant: BUSINESS OBJECTS SOFTWARE LIMITED, Dublin (IE)

(72) Inventors: Deng Feng WAN, Shanghai (CN); Xiaolu YE, Shanghai (CN); Chen ZHOU, Shanghai (CN); Li ZHAO, Shanghai (CN); Weiwei ZHAO, Shanghai (CN)

(73) Assignee: BUSINESS OBJECTS SOFTWARE LIMITED, Dublin (IE)

(21) Appl. No.: 13/688,200

(22) Filed: Nov. 28, 2012

(30) Foreign Application Priority Data
Oct. 29, 2012 (CN) 201210419814.X

(51) Int. Cl. G06F 11/36

(52) U.S. Cl. CPC G06F 11/3604
USPC 717/124

(57) ABSTRACT

Systems and methods for monitoring and improving software development quality are described herein. In accordance with one aspect of the present disclosure, an occurrence of a monitoring task related to source code is monitored. The source code is compiled and tested to produce a test result. The test result is analyzed. The test result analysis includes quality analysis to assess the quality of the source code.

### TECHNICAL FIELD

The present disclosure relates generally to software development, and more particularly, monitoring and improving the quality of software development.

### BACKGROUND

Developing a software product is a long, labor-intensive process, typically involving contributions from different developers and testers. Developers are frequently making changes to the source code, while testers rush to install the software packages, perform regression tests and find bugs or defects. As testers are performing the regression tests, developers check-in more changes to the source code to introduce more features. This could result in a vicious cycle in which more and more features are developed, while more defects are introduced by the changes to the source code. During this process, no one really knows exactly what the current product quality is, and whether the product is good enough to be released. Eventually, the software product may be released with many hidden defects that have not been addressed due to time constraints. When software quality slips, deadlines are missed, and returns on investment are lost.

In an effort to improve the quality of their product offerings and ensure that their products meet the highest possible standards, many enterprises in the software industry implement continuous software quality assurance protocols. The ISO 9001 standard and the Capability Maturity Model Integration (CMMI) model are both popular guidelines in the industry for assuring the quality of development projects. CMMI designates five levels of organization and maturity in an enterprise's software development processes, with each level having a different set of requirements that must be met for CMMI certification to be achieved.

Existing standards and guidelines such as CMMI typically provide only general goals. Details on achieving those goals are typically not offered, and must be developed by the enterprises following the standards. There is generally no known efficient way to assess the quality of the product and visualize the quality trend. It is difficult to forecast the risk and plan accordingly. High-level stake holders, such as product owners, development managers and quality engineers, are unable to obtain regular updates on the overall product quality status.

It is therefore desirable to provide tools for assessing, monitoring and/or improving software quality.

### SUMMARY

Systems and methods for monitoring and improving software development quality are described herein. In accordance with one aspect of the present disclosure, an occurrence of a monitoring task related to source code is monitored. The source code is compiled and tested to produce a test result. The test result is analyzed. The test result analysis includes quality analysis to assess the quality of the source code.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 is a block diagram illustrating an exemplary quality monitoring system;

FIG. 2 shows an exemplary check-in task;

FIG. 3 shows an exemplary build report;

FIG. 4 shows an exemplary time-based monitoring task;

FIG. 5 shows an exemplary method of automated testing;

FIG. 6 shows an exemplary summary report;

FIG. 7 shows an exemplary time period-based dashboard;

FIG. 8 shows another exemplary time period-based dashboard; and

FIG. 9 shows yet another exemplary time period-based dashboard.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

A framework for monitoring and improving software quality is described herein. In one implementation, the present framework provides regular updates of the overall status or quality of a software project by regularly monitoring the quality of the software development and/or testing. Instead of spending tremendous efforts in finding and reporting defects only after the features are ready in the final built package, the present framework monitors the overall quality through a series of processes (e.g., compile checking, code examination, unit testing, functional testing, code coverage analysis, performance testing, etc.) that may be running frequently during the entire software development process to obtain first-hand status of the health of the software project.

A set of summary reports may be provided on a regular basis to report the results of the processes. Alternatively, or in addition thereof, a time period-based dashboard may be provided to present an overview or summary of the project. If the quality index of the project falls below a pre-determined threshold, stakeholders may be notified to take the appropriate action. For example, the dashboard may indicate a red light to signal a significant drop in quality, thereby alerting stakeholders to take action to adjust the development process and bring the quality back on track. These, and other exemplary features, will be discussed in more details in the following sections.

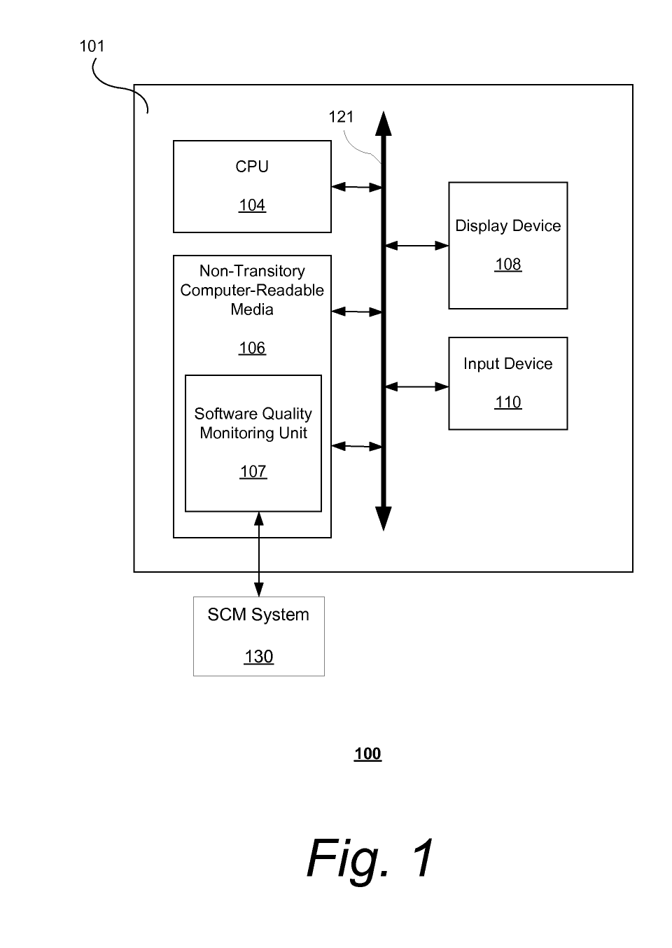

FIG. 1 is a block diagram illustrating an exemplary quality monitoring system 100 that implements the framework described herein. The system 100 may include one or more computer systems, with FIG. 1 illustrating one computer system for purposes of illustration only. Although the environment is illustrated with one computer system 101, it is understood that more than one computer system or server, such as a server pool, as well as computers other than servers, may also be employed.

Turning to the computer system 101 in more detail, it may include a central processing unit (CPU) 104, a non-transitory computer-readable media 106, display device 108, input device 110 and an input-output interface 121. Non-transitory computer-readable media 106 may store machine-executable instructions, data, and various programs, such as an operating system (not shown) and a software quality monitoring unit 107 for implementing the techniques described herein, all of which may be processed by CPU 104. As such, the computer system 101 is a general-purpose computer system that becomes a specific purpose computer system when executing the machine-executable instructions. Alternatively, the quality monitoring system described herein may be implemented as part of a software product or application, which is executed via the operating system. The application may be integrated into an existing software application, such as an add-on or plug-in to an existing application, or as a separate application. The existing software application may be a suite of software applications. It should be noted that the software quality monitoring unit 107 may be hosted in whole or in part by different computer systems in some implementations. Thus, the techniques described herein may occur locally on the computer system 101, or may occur in other computer systems and be reported to computer system 101.

Each computer program may be implemented in a high-level procedural or object-oriented programming language, or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

Non-transitory computer-readable media 106 may be any form of memory device, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks, magneto-optical disks, and Compact Disc Read-Only Memory (CD-ROM).

Computer system 101 may include an input device 110 (e.g., keyboard or mouse) and a display device 108 (e.g., monitor or screen). The display device 108 may be used to display the analysis results (e.g., summary reports, dashboard, etc.) generated by the software quality monitoring unit 107. In addition, computer system 101 may also include other devices such as a communications card or device (e.g., a modem and/or a network adapter) for exchanging data with a network using a communications link (e.g., a telephone line, a wireless network link, a wired network link, or a cable network), and other support circuits (e.g., a cache, power supply, clock circuits, communications bus, etc.). In addition, any of the foregoing may be supplemented by, or incorporated in, application-specific integrated circuits.

Computer system 101 may operate in a networked environment using logical connections to one or more remote client systems over one or more intermediate networks. These networks generally represent any protocols, adapters, components, and other general infrastructure associated with wired and/or wireless communications networks. Such networks may be global, regional, local, and/or personal in scope and nature, as appropriate in different implementations.

The remote client system (not shown) may be, for example, a personal computer, a mobile device, a personal digital assistant (PDA), a server, a router, a network PC, a peer device or other common network node, and typically includes many or all of the elements described above relative to computer system 101. The remote client system may also include one or more instances of non-transitory computer readable storage media or memory devices (not shown). The non-transitory computer readable storage media may include a client application or user interface (e.g., graphical user interface) suitable for interacting with the software quality monitoring unit 107 over the network. The client application may be an internet browser, a thin client or any other suitable applications. Examples of such interactions include requests for reports or dashboards. In turn, the client application may forward these requests to the computer system 101 for execution.

In one implementation, the software quality monitoring unit 107 is coupled to (or interfaces with) a Software Configuration Management (SCM) system 130. The SCM system 130 may be implemented by a remote computer system, or the same computer system 101. The SCM system 130 tracks and controls changes in the software. More particularly, the SCM system 130 may be designed to capture, store and manage access and provide version control for software source files, designs and similar files. An example of an SCM system 130 includes, but is not limited to, a SourceSafe, Source Code Control System (SCCS) or PVCS system.

The software quality monitoring unit 107 may be designed to work with the SCM system 130 to monitor the overall quality of a software project. In one implementation, the software quality monitoring unit 107 receives the software project files from the SCM system 130, evaluates the overall quality of the project through a series of compilation and testing processes and reports the results of the evaluation to stakeholders (e.g., developers, testers, owners, engineers etc.). Advantageously, instead of spending tremendous resources on finding and reporting defects only after the features are ready in the final software product, regular updates may be provided on the current status of the project during its development process.

In accordance with one implementation, the software quality monitoring unit 107 implements the compilation and testing processes using monitoring tasks. In one embodiment, monitoring tasks may include a check-in task, and a time-based task. These monitoring tasks may be triggered by different events. For example, the check-in task may be triggered whenever a developer “checks-in” a new change to the SCM system 130. The time-based task may be triggered by time events. For example, the time-based task may be triggered at a regular time interval or a predetermined time. The time-based task may also be triggered when an install package of the software project is ready or available for installation. Other types of monitoring tasks having different triggering events may also be used.

The triggering event may initiate an automatic compile-and-build process and the corresponding monitoring task. Depending on the type of monitoring task, different sets of tests may be performed. For example, the check-in task may involve less extensive testing (e.g., unit testing only), while the time-based task may involve more extensive testing. As an example, testing for a monitoring task may include, but is not limited to, code coverage analysis, functional testing, quality checking, unit testing, as well as other types of tests. For an install package based task, testing may include, but is not limited to, functional testing, performance testing as well as other types of tests. Once the tests are completed, the system may evaluate the test results by, for example, computing a quality index and/or summarizing the test results in a report or a dashboard. The system may store the test and/or evaluation results in a database, and further send a notification to the corresponding stakeholders. Upon receiving the notification, the stakeholders may promptly fix any detected failures or defects related to the software project. More details of these and other exemplary features will be provided in the following sections.

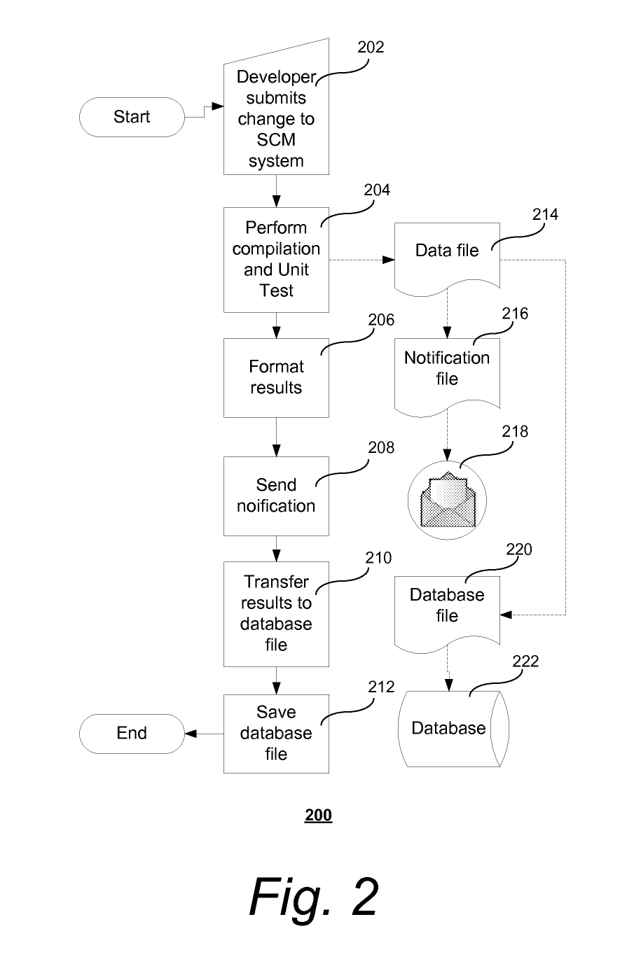

FIG. 2 shows an exemplary check-in task (or process flow) 200 for monitoring and reporting the overall quality of a software project. The check-in task 200 begins at 202 when a developer (or any other user) submits a change to the SCM system 130.

At 204, after the change has been accepted by the SCM system 130, the software project is automatically compiled or “built” to take into account the new change to the source code. One or more unit tests are then performed on individual software project modules. Unit tests are designed to exercise individual units of source code, or sets of one or more program modules, so as to determine that they meet reliability requirements. The results of the unit testing may be stored in a data file 214, such as an Extensible Markup Language (XML) file. It should be understood that other types of file formats may also be used.

At 206, the test results and any other relevant information are presented in a suitable file format for notification. The data file 214 is converted to a notification file 216 of a suitable format, depending on the type of notification to be sent. In some implementations, the notification is in the form of an email, a web-page, a facsimile document, a pop-up display window, a text message, a proprietary social network message, and/or a notification sent through a custom client application (e.g., mobile device application). In one implementation, the notification file 216 includes a Hypertext Markup Language File (HTML) file that can be viewed using a web browser, email software application or any other software program. It should be understood that other types of standard file formats, such as Rich Text Format (RTF) or Portable Document Format (PDF), may also be used.

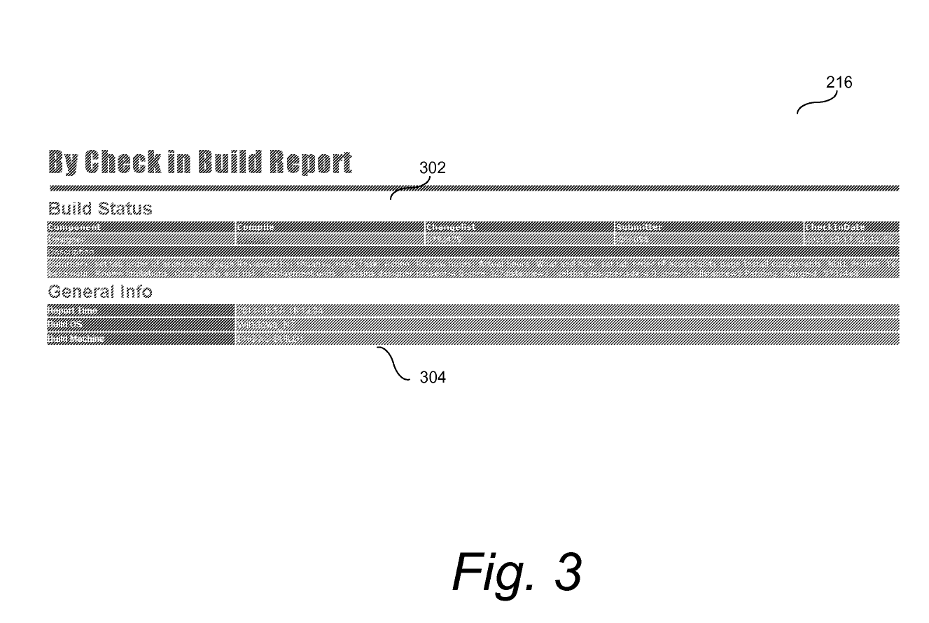

FIG. 3 illustrates an exemplary build report (or notification file) 216. As shown, the build status 302 and general information 304 may be included in the build report. The build status 302 includes, for example, the software area name, success/failure status of the build or test, change list identifier, submitter identifier, check-in date, and a description of the changes made and tests performed. General information 304 may include the time of report generation, the operating system and the model of the machine in which the compilation was performed. By filtering the information in the data file 214 along various dimensions, other types of information may also be provided in the report.

Referring back to FIG. 2, at 208, the notification is automatically sent to the respective stakeholders. In one implementation, the notification is sent in the form of an email 218. Other forms of notification may also be provided. Exemplary stakeholders include testers, developers, programmers, engineers, product designers, owners, etc. Whenever a defect is detected, the notification may alert the respective stakeholder to take any necessary action. For example, the developer may be prompted to fix the defect immediately so as to avoid introducing more severe issues. In other cases, the project manager may decide to withhold the release of the project for internal usage or demonstration due to the detected defects.

At 210, the test results are transferred to a database file. In one implementation, the data file 214 (e.g., XML file) containing the results is converted into a database file 220. The database file 220 stores the test results in a format that is compatible with the database (DB) 222. For example, the database file 220 may be a Structured Query Language (SQL) file. The DB 222 may be implemented using an industry standard relational database management system (RDBMS), although other implementations are also acceptable. In one implementation, the database may be Microsoft SQL server. At 212, the generated database file 220 is stored in the database 222 for future access or retrieval.

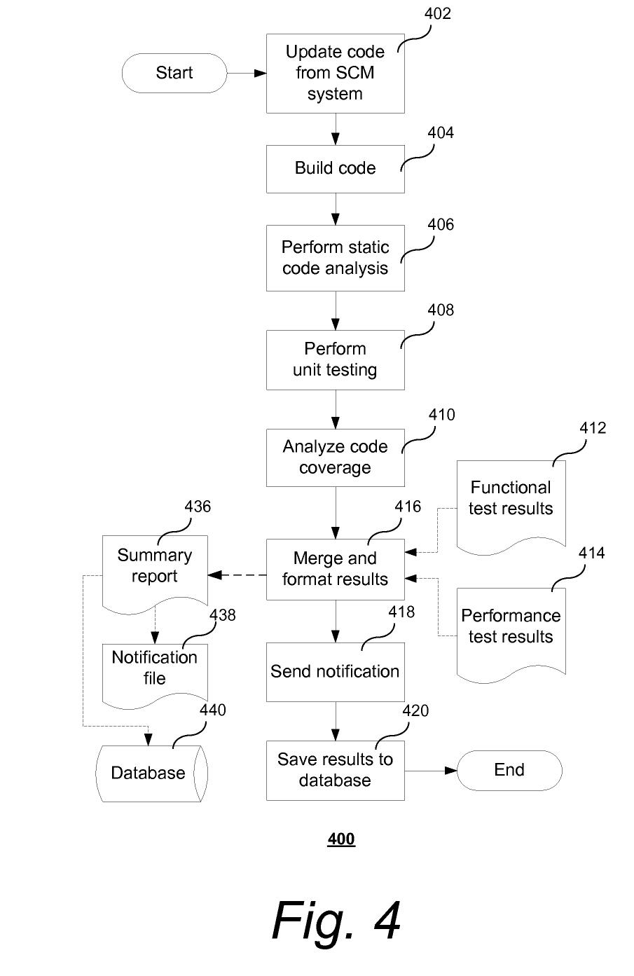

FIG. 4 shows a more extensive exemplary time-based monitoring task 400. The time-based monitoring task 400 may be triggered by a time event and the availability of the install package of the software project. For example, the time-based task 400 may be triggered at regular time intervals (e.g., nightly, daily, weekly, etc.) or at predetermined times (e.g., midnight, weekends or holidays) when there is less likelihood of anyone checking-in changes to the SCM system 130. The time-based task may also be triggered when the install package of the software project is ready for installation. The readiness of the install package minimizes installation related issues and hence reduces false alarm failures.

At 402, after the task 400 starts, the source code from the SCM system 130 is updated. The update may be initiated by an automated build system, such as the Java-based CruiseControl (or CruiseControl.NET) system. Other automated build systems, such as SVN, MSBuild, CodeProject, Jenkins or other non Java-based systems, may also be used. The automated build system may be implemented as a daemon process to continuously (or periodically) check the SCM system for changes to the source code. In one implementation, the automated build system triggers an SCM client application to download the latest version of the source code from the SCM system 130.

At 404, the automated build system builds (or compiles) the updated source code into an executable program.

At 406, static code analysis (or static program analysis) is performed on the updated source code (or object code). Such static code analysis may be invoked by the automated build system when the SCM system client completes the updating of the source code. Static code analysis is the analysis of software that is performed without actually executing programs built from that software, whereas actually running the program with a given set of test cases is referred to as dynamic testing. For example, the dynamic testing includes functional testing and performance testing. Static tests facilitate the validation of applications, by determining whether they are buildable, deployable and fulfill given specifications.

In one implementation, static code analysis is performed by using a static code analyzer tool, such as Cppcheck, FindBugs, FlexPMD, etc. It should be understood that other types of tools may also be used. The static code analyzer tool may check for non-standard code in one or more programming languages, such as C/C++, Java, Flex, Pascal, Fortran, etc. For example, CppCheck may be used to check the quality of C/C++ code, FindBugs for Java code, and FlexPMD for Flex code. A code scope may be specified for each static code analyzer tool to perform the analysis. The results of the code analysis may be saved in a data file (e.g., XML file).

At 408, unit testing is performed on the updated source code. During unit testing, one or more unit tests may be performed on individual units of source codes, or sets of one or more program modules. Unit testing seeks to test the reliability of the source code, but not the functional issues. In one implementation, the unit testing is initiated by the automated build system after the completion of the static code analysis at 406. The results and other relevant information of the unit testing may be recorded in a data file (e.g., XML file). Examples of such information include, but are not limited to, number of unit tests, pass rate, code language, etc.

At 410, code coverage is analyzed. “Code coverage” describes the degree to which the source code has been tested. For example, code coverage data may indicate the number of source code files, units or modules that have been covered by the unit testing. Code coverage data may be gathered at several levels, including a line, branch, or method, executed during the unit testing. The resulting code coverage data may be stored in data files, and used to generate reports that show, for example, where the target software needs to have more testing performed.

At 416, the automated build system merges and formats the results and other relevant information from the respective tests (e.g., static code analysis, unit testing, code coverage analysis, etc.). The information may be merged by, for example, appending the data files (e.g., XML file) containing the information into a single data file. The information may be formatted into a summary report 436.

The information optionally includes functional test results 412, and/or performance test results 414. In some implementations, a test management tool is used to perform the functional and/or performance tests so as to obtain the results (412 and 414). The test management tool may be used to manage and monitor test cases, project tasks, automated or manual tests, environments and/or defects (or bugs). For example, the test management tool may be used to drive (or start) the target machine, design and/or execute workflow, install software builds, execute automated functional and performance tests, etc. Exemplary test management tools include SAP's Automation System Test Execution, HP Quality Center, IBM Rational Quality Manager, and so forth. The test management tool may reside in the same computer system 101 (as described in FIG. 1) or in a remote server that is communicatively coupled to the computer system 101.

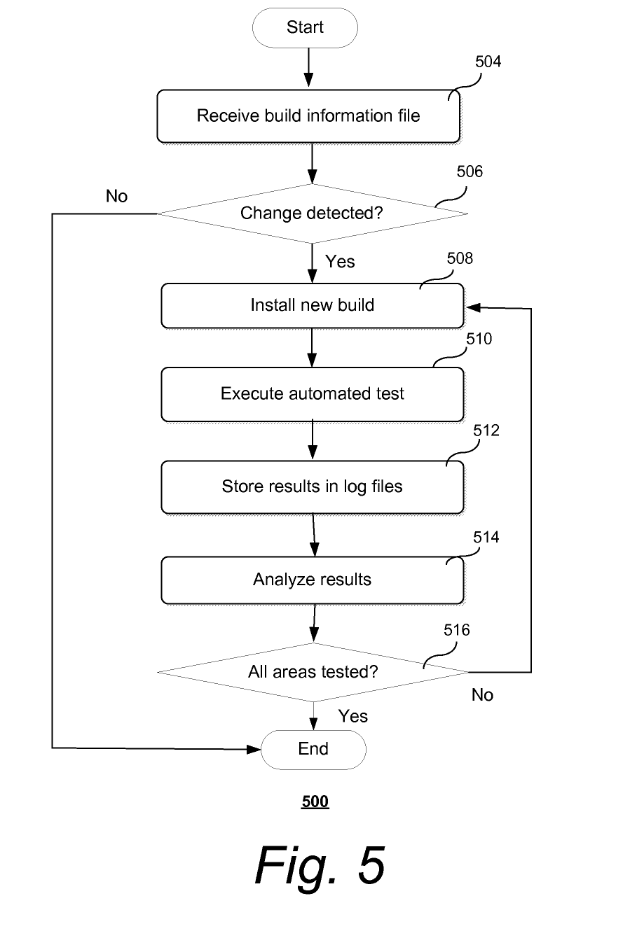

FIG. 5 shows an exemplary method 500 of automated testing. This method 500 may be implemented by a test management tool, as discussed previously. The automated testing method 500 may be performed concurrently with the time-based monitoring task 400 described with reference to FIG. 4. It may be initiated whenever a new build and/or install package of the software project is available.

Referring to FIG. 5, at 504, the test management tool receives a build information file. In one embodiment, a standalone application monitors for the availability of install packages. Once install packages are ready, the standalone application refreshes the build information file. Other techniques for monitoring and refreshing build information may also be useful. In one implementation, the build information file stores the latest build package number and install package location. Other information may also be included.

At 506, the test management tool inspects the build information file to detect any change to the build. If a change is detected and an install package is available, the test management tool triggers one or more build-related tasks. The build-related tasks may include steps 508 to 516 for implementing automated testing. Other build-related tasks, such as silent software installation, may also be triggered.

At 508, the test management tool installs a new build of the software project after a change is detected.

At 510, the test management tool executes one or more automated tests. The automated tests may be dynamic tests. For example, the automated tests may include one or more automated functional and/or performance tests.

In one implementation, the test management tool executes one or more automated functional tests. A functional test seeks to verify whether a specific function or action of the software code meets design requirements. Functions may be tested by, for example, feeding the software area with input parameters and examining the output result. Such tests may be designed and written by testers, and may last a few hours. In addition, different areas may be tested simultaneously.

Alternatively, or in combination thereof, the test management tool may perform one or more automated performance tests. A performance test generally determines how responsive, stable and/or reliable the system is under a particular workload. As performance testing may take a long time to run, the scope of testing may be restricted to only very typical scenarios to obtain prompt performance test results of the latest build. In addition, the performance testing may be performed in parallel on several machines to increase the efficiency.

At 512, the test management tool stores the results of the automated tests in one or more log files. The log files may be categorized in different folders according to, for example, the date of test execution.

At 514, the results are analyzed. In one implementation, the results are analyzed on a daily (or regular) basis. For example, a software application (e.g., Java application, performance test driver, etc.) may be executed to perform an automated results analysis task. The application may parse the latest log files from the respective log folder and analyze the results. For example, the application may determine the number of cases that passed and/or failed the tests. The application may then write the summary information to a summary data file (e.g., XML file) for temporary storage. The summary information may further include other test-related information, such as the build information, machine configuration information, testing time, test results (e.g., operation, 90^{th} percentile time spent, etc.), and so forth. The summary information may be stored in each row of a database for each respective software area.

In one implementation, the database includes data from prior tests on previous products that may be used as benchmark data for assessing the current project's test results. For example, a software application (e.g., Java application) may be executed to generate a daily performance report. The application may access the database to retrieve the benchmark data and latest test results, and compare them to determine the performance of the current software project under test. If the performance of the current project is slower than the benchmark case by a predetermined threshold (e.g., 10%), it can be considered a “fail.” Conversely, if the relative performance is faster by a predetermined threshold, then it can be considered a “pass.” An exemplary daily performance report is shown in Table 1 below:

TABLE 1

| Area | Status | Note |
|---|---|---|
| Xcelsius Client SWF | Pass | |
| Xcelsius Enterprise BEx | Fail | ADAPT0056263 |
| Xcelsius Enterprise MS OLAP | Fail | ADAPT005054 |
| Xcelsius Enterprise Oracle | Pass | |

At 516, the test management tool checks to see if all areas of the software project are tested. If all the tests are not completed, the method 500 proceeds to install a new build for the next area. The automated testing steps 508-516 may be repeated for several iterations and with multiple users. If all the tests are completed, the method 500 ends. The functional and performance test results, including the summary information, may be communicated to the computer system 101 to be included in the summary report 436.

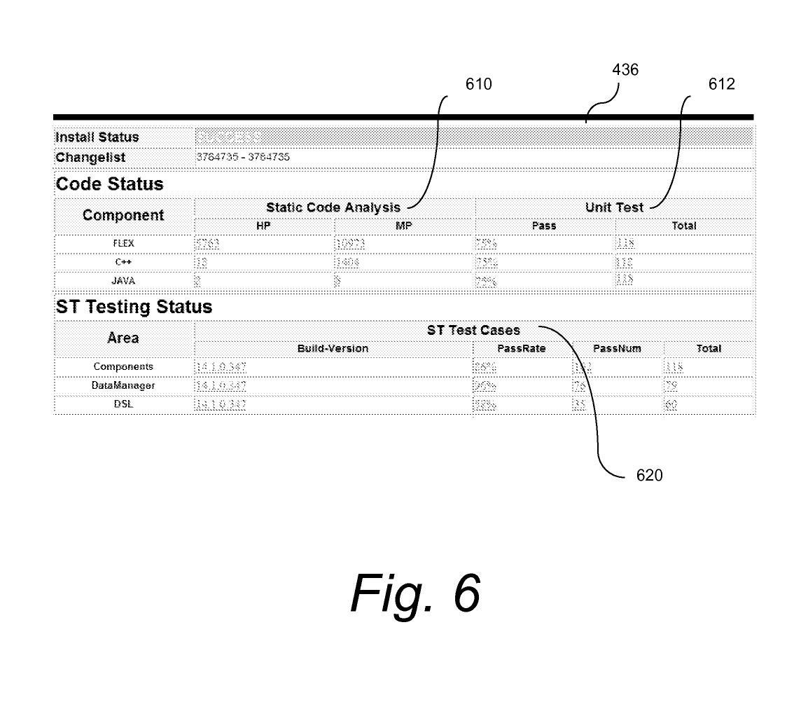

FIG. 6 shows an exemplary summary report 436. Summary reports may be generated regularly to provide frequent updates of the project status. The exemplary summary report 436 shows the test results of the various tests, such as the code quality results for the static code analysis 610, pass/fail rate (or pass/fail number) for unit tests 612, and the pass/fail rate (or pass/fail number) for automated tests 620. Other information, such as the install status and change list identifier, may also be included in the summary report 436. By presenting the software quality from a more comprehensive perspective, testers and developers will be urged to fix any defects in quality at an early stage before all features are ready.

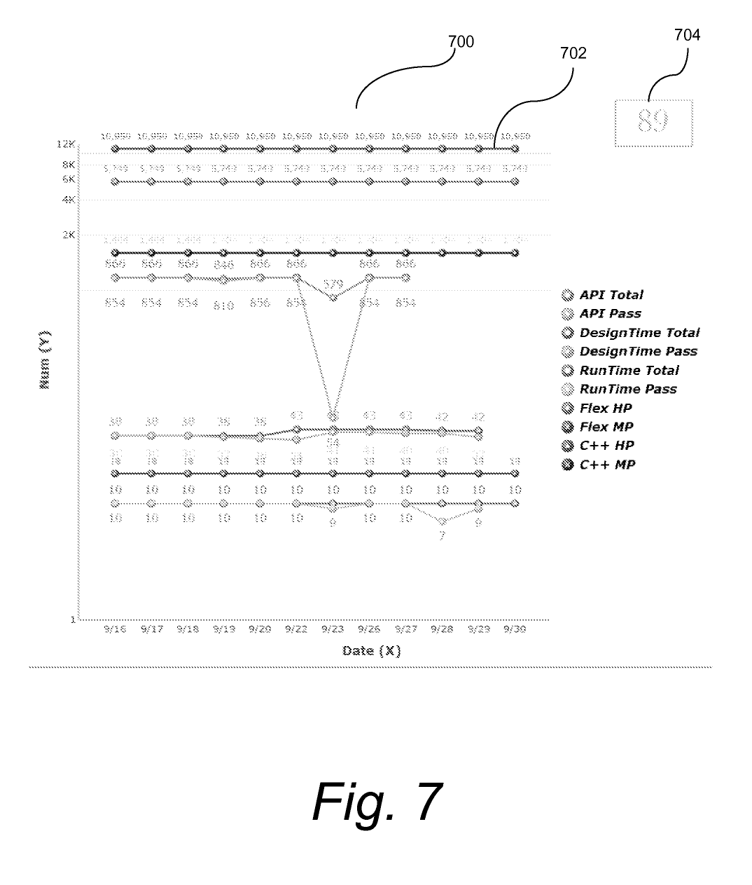

Alternatively, or in combination thereof, the summary report 436 may be converted to a dashboard, such as those shown in FIGS. 7, 8 and 9, which will be described in more detail later. The dashboard may be sent out regularly (e.g., monthly or quarterly) to stakeholders to report the software project's overall quality tendency. Such regular reporting may indicate, for example, whether the software team is doing a better job over time, or whether something is going wrong and adjustments are required. The dashboard may alert the stakeholders when the quality index score is in the “red zone” to make prompt adjustments so as to bring it back on the right track.

Referring back to FIG. 4, at 418, the summary report 436 may be converted into a notification file 438 (e.g., HTML email), which is then sent to the respective stakeholders at 418. The notification may be sent via, for example, a Simple Mail Transfer Protocol (SMTP) service or any other communication service. The notification file 438 may be customized to present only data that is relevant to the particular stakeholder. It may also include one or more links to present other data or details that the stakeholder may occasionally be interested in.

At 420, the summary report 436 is saved in a database 440 for future retrieval and analysis. This may be achieved by using, for example, a command line tool such as an Apache Ant SQL task. Any other tools are also useful for managing the database 440.

In one implementation, the summary report 436 is retrieved from the database 440 to generate a dashboard to notify stakeholders of the current status or overall quality of the software project. A dashboard may include different elements to present aggregated views of data using, for example, appropriate software quality indicators, key performance indicators (KPIs), metrics, trends, graphs, data visualizations and interactions. For example, at the highest level, a dashboard may include a user interface (UI) or dashboard panel. Within the panel there may be one or more viewing zones which correspond to the second highest level. A viewing zone includes one or more visual components to facilitate data visualization. Providing other types of components or elements may also be useful. Depending on the design, a viewing region may include sub-viewing regions having different visual components. The dashboard may also be provided with different features or functions. For example, components or elements, such as drop down menus, sliders and command buttons for performing “what if” analyses and dynamic visualization of data may be provided to enable interactions by a user at runtime. It is believed that the use of dashboards enables quick understanding of the data to facilitate better and more efficient decision making In one embodiment, the dashboard design application is SAP® BusinessObjects™ Xcelsius® Enterprise. Other types of dashboard design applications may also be useful. For example, the dashboard design application may be SAP® Visual Composer.

FIG. 7 shows an exemplary time period-based dashboard 700. The dashboard 700 presents one or more quality graphs that shows the day-by-day quality trend of the software project over a predefined range of dates. In particular, each quality graph 702 may represent the number of times a software component passes (i.e. fulfills a predefined criteria) or the total number of times it is tested.

In one implementation, the dashboard 700 further includes a quality index 704 to indicate the health of the software project. The quality index 704 may be a numerical value ranging from, for example, 0 to 100, with 100 being the best. It may be derived by combining weighted axes of quality (e.g., Coding Violations, Code Complexity, Style violations, Test Coverage, Document Coverage, etc.) using a predefined formula. The quality index 704 may be used to assess and rate the quality of the software project, and/or show trends over time (e.g., weeks or months) of whether or not the overall quality of the project is improving. The quality index 704 may be included in the summary report and/or dashboard to alert stakeholders to take action if the quality falls below a predetermined level. It can also be used as a basis for a decision on whether to launch, terminate or release a project.

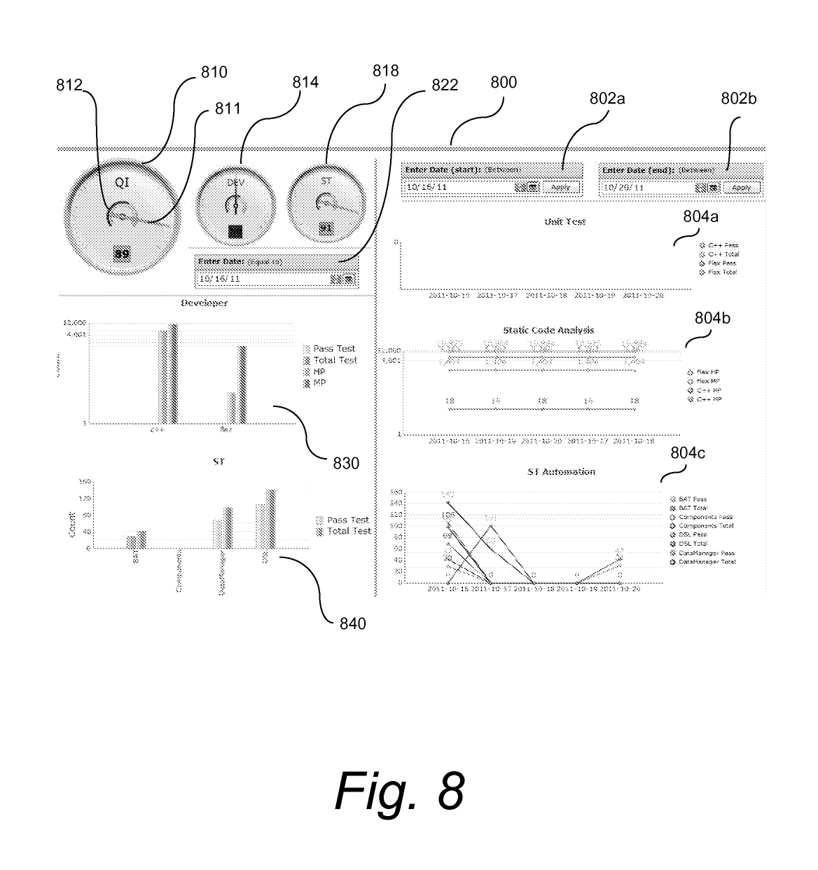

FIG. 8 shows another exemplary time period-based dashboard 800. The dashboard 800 provides user-interface components 802a-b (e.g., text box or drop-down menu) to allow the user to select the specific start and end dates respectively of the quality graphs. The user may also select a time period range (e.g., two or three months) over which the quality graphs and indicators are presented. The quality graphs 804a-c for each type of testing (e.g., unit testing, static code analysis, automated testing, etc.) may be separately presented in different charts. In addition, one or more different types of graphs (e.g., line graphs, bar graphs, pie charts, etc.) may be used to display the test results. By providing an overall view of the quality of the project, various stakeholders may see the trending of data over the specified period of time. This allows them to make decisions and react to issues before those issues become problems.

In one implementation, the dashboard 800 includes a graphical representation 810 of a quality index (QI). The QI graphical representation may be gauge that displays the instantaneous quality index score of the software project. When the pointer 811 rotates to red zone 812, thereby indicating that the QI score has fallen below a predetermined level, the respective stakeholder may be alerted to take the appropriate action. It is understood that other types of graphical representations are also useful.

Similar graphical representations (814 and 818) may be provided to present the instantaneous developer (DEV) and software tester (ST) quality scores, which may be used to derive the overall QI score, as will be described in more detail later. In addition, graphical charts (830 and 840) (e.g., bar charts) may be provided to display the values of the different components or areas used to compute the DEV and ST quality scores. A user-interface component 822 (e.g., drop-down menu, text box, etc.) may further be provided to allow the user to specify the date at which the data is collected to compute these QI, DEV and ST scores.

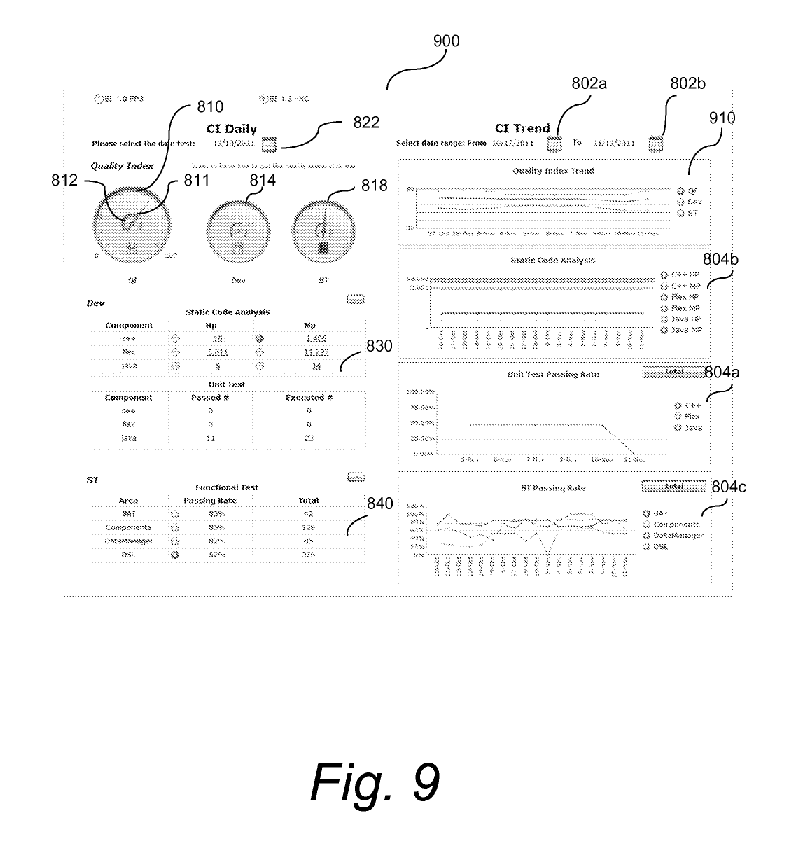

FIG. 9 shows another exemplary time period-based dashboard 900. As shown, graphical representations (810, 814 and 818) displaying the instantaneous QI, DEV and ST quality scores are provided. In addition, a graphical line chart 910 is provided to display the trend of the of the QI, DEV and ST scores over a period of time. Even further, graphical charts (e.g., tables) (830 and 840) are used to display the values of the different components or areas used to compute the DEV and ST quality scores.

As mentioned previously, the overall QI index may be derived based on a developer (DEV) quality score and a software tester (ST) quality score. The developer (DEV) quality score is derived based on one or more source code metrics. For example, the DEV quality score may be derived based on a weighted combination of the number of coding violations, code complexity, duplication coverage, code coverage and/or documentation information. Other metrics of source code quality, such as style violations, may also be considered. The data used to compute these source code metrics may be obtained (or retrieved from the database) using the aforementioned techniques implemented by, for example, computer system 101.

In one implementation, the DEV quality score is based at least in part on a coding violations score (Coding), otherwise referred to as a code compliance index. A coding violation refers to a deviation from accepted coding standards. Such coding standards may include internally defined standards, industry-wide standards or standards particularly defined for a given software development project by, for example, the developer and/or client. The coding violations may be categorized into different groups, depending on the level of severity. Such categories include, but are not limited to, “Blocked” (B), “Critical” (C), “Serious” (S), “Moderate” (M) and “Info” (I), in increasing levels of severity. It is understood that other category labels may also be assigned.

The categorized code violations may be totaled for each severity level to provide the corresponding violation count. To compute the coding violations score (Coding), these violation counts may be weighted and normalized according to the total number of valid (or executable) code lines (ValidCodeLines) as follows:

Coding=(B×10+C×5+S×3+M×1+I×1)/ValidCodeLines (1)

As shown by Equation (1) above, the more severe coding violations (e.g., Blocked) may be assigned relatively higher weights (e.g., 10), since they have more impact on the code quality. Conversely, the less severe coding violations (e.g., Info) are assigned relatively lower weights (e.g., 1), as they have less impact on the code quality.

In one implementation, the DEV quality score is based at least in part on a code complexity score (Complexity). Code complexity may be measured by cyclomatic complexity (or conditional complexity), which directly measures the number of linearly independently paths through a program's source code. Sections of the source code may be categorized into different levels of code complexity, depending on the number of linearly independently paths measured. Exemplary categories include, for example, Complexity>30, Complexity>20, Complexity>10, Complexity>1, etc. Other categorical labels may also be assigned.

The number of code sections may be totaled for each category to provide corresponding complexity counts. These complexity counts may then be weighted and normalized according to the total number of valid or executable code lines (ValidCodeLines) to compute the code complexity score (Complexity) as follows:

Complexity=(Complexity>30×10+Complexity>20×5+Complexity>10×3+Complexity>1×1)/ValidCodeLines (2)

As shown by Equation (2) above, the more complex code sections (e.g., Complexity>30) are assigned relatively higher weights (e.g., 10), since they affect the code quality more. For example, codes with high complexity are difficult to maintain due to their tendency to cause bugs. Conversely, the less complex code sections (e.g., Complexity>1) are assigned relatively lower weights (e.g., 1), as they have less impact on the code quality.

In one implementation, the DEV quality score is based at least in part on a duplication coverage score (Duplication). A “duplicate code” refers to a sequence of source code that occurs more than once within a program. Duplicate source code is undesirable. For example, duplicate source codes are long repeated sections of code which differ by only a few lines or characters, making it difficult to quickly understand them as well as their purpose. A duplication coverage score (Duplication) may be computed by normalizing the total number of duplicated code lines (DuplicatedLines) by the total number of valid or executable code lines (ValidCodeLines), as follows:

Duplication=DuplicatedLines/ValidCodeLines (3)

In some implementations, the DEV quality score is based at least in part on a code coverage score (UnitTest). As discussed previously, code coverage describes the degree to which the source code has been tested. Code coverage (COV) may be quantified by, for example, a percentage. The code coverage score (UnitTest) may be determined by computing a weighted combination of COV and the test success rate (SUC), such as follows:

UnitTest=0.7×COV+0.3×SUC (4)

In some implementations, the DEV quality score is based at least in part on a documentation score (Document). Source code documentation is written comments that identify or explain the functions, routines, data structures, object classes or variables of the source code. A documentation score may be determined by finding the percentage (documented_API_Percentage) of an application programming interface (API) that has been documented:

Document=documented_API_Percentage (5)

Once these source code metrics have been determined, the DEV quality score (X) may be computed by combining the source code metrics into a global measure as follows:

X=100−35×Coding−25×(1−Test)−15×Complexity−15×Duplications−10×(1−Document) (6)

As shown, relatively higher weights (e.g., 35) are assigned to source code metrics that are deemed to impact the quality of the source code more (e.g., Coding). The DEV quality score may range from 0 to 100, which 100 being the best quality score. It is understood that other ranges (e.g., 0 to 1000) may also be implemented. Providing other weight values for metrics may also be useful.

More particularly, the DEV quality score (X) may be computed as follows:

$$X = 100 - \frac{\begin{matrix}a 1 \times 10 + a 2 \times \\ 5 + a 3 \times 3 + a 4\end{matrix}}{f} \times 35 - ( 1 - ( \begin{matrix}b 1 \times 70 \% + \\ b 2 \times 30 \%\end{matrix} ) ) \times 25 - \frac{\begin{matrix}c 1 \times 10 + c 2 \times \\ 5 + c 3 \times 3 + c 4\end{matrix}}{f} \times 15 - \frac{d}{f} \times 15 - ( 1 - e ) \times 10 \qquad ( 7 )$$

where

a1=the number of Blocked coding issue

a2=the number of Critical coding issue

a3=the number of Serious coding issue

a4=the number of Moderate coding issue

b1=Unit Test Code Coverage (%)

b2=Unit Test Success rate (%)

c1=the number of source code where Complexity>30

c2=the number of source code where Complexity>20

c3=the number of source code where Complexity>10

c4=the number of source code where Complexity>1

d=the number of duplicated code lines

e=the documented API percentage (%)

f=the number of valid code lines

The software tester (ST) quality score may be derived based on one or more automated test metrics, such as a functional test metric (Functional) and a performance test metric (Performance). The data used to compute these automated test metrics may be obtained (or retrieved from the database) using the aforementioned techniques implemented by, for example, computer system 101.

In one implementation, a functional test metric (Functional) is determined by computing a weighted combination of the code coverage (COV) and the test success rate (SUC), such as follows:

Functional=0.6×COV+0.4×SUC (8)

A performance test metric (Performance) may be determined by computing a weighted combination of the performance delta compared to the base line (DELTA) and the test success rate (SUC), such as follows:

Performance=0.6×DELTA+0.4×SUC (9)

Once the automated test metrics are obtained, the ST quality score (Y) may be determined by computing a weighted combination of these metrics, such as follows:

Y=60×Functional+40×Performance (10)

More particularly, the ST Quality Score (Y) may be computed as follows:

Y=(a1×70%+a2×30%)×60+(b1×60%+b2×40%)×40 (11)

where

a1=Functional Test Code Coverage (%)

a2=Functional Test Success rate (%)

b1=Performance delta compared to the base (%)

b2=Performance Test Success rate (%)

The overall quality index (QI) may then be computed by determining a weighted combination of the DEV and ST quality scores, such as follows:

QI=X×60%+Y×40% (12)

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method for monitoring and improving software development quality comprising:
monitoring for an occurrence of a monitoring task related to a source code;
compiling the source code;
testing the source code to produce a test result; and
analyzing the test result, wherein analyzing the test result includes quality analysis to assess the quality of the source code.

2. The method of claim 1 further comprising computing a quality index corresponding to the test result.

3. The method of claim 1 wherein the monitoring task comprises a check-in task or time-based task.

4. The method of claim 3 wherein the check-in task is triggered when a new change to the source code is checked-in by a developer.

5. The method of claim 3 wherein the time-based task is triggered at a regular time interval, a predetermined time or when an install package is available for installation.

6. The method of claim 1 further comprising sending a notification of the test result to a stakeholder.

7. The method of claim 6 wherein the notification is in a form of an email, a web-page, a facsimile document, a pop-up display window, a text message, a proprietary social network message or a custom client application.

8. The method of claim 1 further comprising:
converting the test result to a database file; and
storing the database file in a database.

9. The method of claim 8 wherein the database comprises database files from prior tests of previous products as benchmark data for assessing a current product.

10. The method of claim 1 wherein compiling the source code comprises updating the source code into an executable program using an automated build system.

11. The method of claim 10 wherein the automated build system comprises a Java-based or non Java-based system.

12. The method of claim 1 wherein testing the source code comprises:
performing a static code analysis;
performing a unit test;
performing code coverage analysis;
merging results and relevant information from the test and analysis into a single data file; and
formatting the single data file into a summary report.

13. The method of claim 12 wherein the relevant information comprises functional test results and performance test results.

14. The method of claim 12 wherein the summary report comprises a dashboard or a notification file.

15. The method of claim 14 wherein the dashboard comprises a quality index to indicate the health of the software development.

16. The method of claim 15 wherein the quality index is derived based on a weighted developer quality score and a weighted software tester quality score.

17. A non-transitory computer-readable medium having stored thereon program code, the program code executable by a computer to:
monitor for an occurrence of a monitoring task related to a source code;
compile the source code;
test the source code to produce a test result; and
analyze the test result, wherein analyze the test result includes quality analysis to assess the quality of the source code.

18. The non-transitory computer-readable medium of claim 17 wherein compile the source code comprises:
performing a static code analysis;
performing a unit test;
performing code coverage analysis;
merging results and relevant information from the test and analysis into a single data file; and
formatting the single data file into a summary report.

19. A system comprising:
a non-transitory memory device for storing computer readable program code; and
a processor in communication with the memory device, the processor being operative with the computer readable program code to:
monitor for an occurrence of a monitoring task related to a source code;
compile the source code;
test the source code to produce a test result; and
analyze the test result, wherein analyze the test result includes quality analysis to assess the quality of the source code.

20. The system of claim 19 wherein compile the source code comprises:
performing a static code analysis;
performing a unit test;
performing code coverage analysis;
merging results and relevant information from the test and analysis into a single data file; and
formatting the single data file into a summary report.
